(19) United States
(12) Patent Application Publication
(10) Pub. No.: US 2018/0178853 A1
(43) Pub. Date: Jun. 28, 2018

(54) AXLE OR CHASSIS COMPONENT FOR A MOTOR VEHICLE

(71) Applicant: Benteler Automobiltechnik GmbH, Paderborn (DE)

(72) Inventors: Dieter FRIESEN, Paderborn (DE); Thomas HENKSMEIER, Lippstadt (DE); Erik HOCHAPFEL, Gudensberg (DE)

(21) Appl. No.: 15/837,255

(22) Filed: Dec. 11, 2017

(30) Foreign Application Priority Data
Dec. 12, 2016 (DE) 10 2016 124 100.8

(51) Int. Cl. B62D 29/00; B62D 21/15; B62D 27/02; B21B 1/22

(52) U.S. Cl. CPC B62D 29/007; B21B 1/22; B62D 27/02; B62D 21/155

(57) ABSTRACT

An axle or chassis component for an axle of a motor vehicle is disclosed. At least a part of the axle or chassis component is provided by a one-piece and single-material formed component. The formed component has at least three regions, wherein one region has a smaller wall thickness in relation to the other two regions, and the region with a smaller wall thickness is arranged between the two regions with a greater wall thickness.

### RELATED APPLICATIONS

The present application claims the priority of German Application Number 10 2016 124 100.8, filed Dec. 12, 2016, the disclosure of which is hereby incorporated by reference herein in its entirety.

### BACKGROUND

### 1. Field of the Invention The disclosure is related to an axle or chassis component for an axle of a motor vehicle.

### 2. Description of the Related Art

Axle or chassis components for use on motor vehicles, which consist of steel materials and in particular are produced as formed sheet metal components or welded component assemblies, are known from the prior art. Thus, for example axle subframes are known. Such axle subframes are arranged beneath a motor vehicle body. Parts of the vehicle axle, in particular links, are coupled to the axle subframe.

In addition to a shell construction, it is known to build axle subframes from individual profiles or struts. These are welded together. In particular, such an axle subframe has two longitudinal members. These are arranged externally in the installed position in the motor vehicle and are directed in the vehicle longitudinal direction. The two longitudinal members are connected together via cross members which are oriented in the vehicle transverse direction.

The individual profile components are produced in particular by forming operations, including roll forming operations. In particular, sheet metal materials are processed with a homogeneous wall thickness therein. A disadvantage is that the wall thickness of the sheet metal material is selected to be large enough in the attachment region to comply with the required demands and bending or rupturing is prevented. In the regions that are loaded less, by contrast, the wall thickness of the sheet metal material sometimes has too large dimensions, with the result that the weight, but also the material usage for producing an axle subframe of the type in question is increased. Such axle subframes of the type in question are known for example from DE 10 2014 108 836 or DE 10 2011 050 657, but these are produced from light metal.

Also known from the prior art are torsion beam axles. Such torsion beam axles have a torsion tube extending centrally in the vehicle transverse direction. Coupled to the ends of the torsion tube are longitudinal swing arms. The longitudinal swing arms are oriented in the vehicle longitudinal direction. Thus, during the deflection and rebound process of a vehicle wheel, the torsion tube twists about its own longitudinal axis.

Proceeding from the prior art, the object of the present invention is to optimize axle or chassis components mentioned at the beginning in terms of the dead weight and load-bearing capacity.

### SUMMARY

According to one exemplary embodiment, an axle or chassis component for an axle of a motor vehicle is produced as a sheet metal formed component. It is a one-piece and single-material formed component. If the axle or chassis component is produced as a welded component assembly, at least one of these parts which are welded together is provided as a one-piece and single-material formed component.

According to one exemplary embodiment, the formed component is distinguished by the fact that it has at least two regions with different wall thicknesses, wherein one region has a smaller wall thickness in relation to the other region. Preferably, the region with a smaller wall thickness is located between the two regions with a greater wall thickness. The region with a smaller wall thickness is thus arranged between two regions with a greater wall thickness. The region with a smaller wall thickness can be completely surrounded by the regions with a greater wall thickness, or be enclosed thereby. The region with a smaller wall thickness can also be adjoined by two regions with a greater wall thickness and extend across the entire width of a sheet metal plate blank. It is also possible for the region with a smaller wall thickness to be arranged in a peripheral region. It is then at least partially surrounded circumferentially by the region with a greater wall thickness.

According to one exemplary embodiment, an inner region, also referred to as internal region, includes a thinner wall thickness. The at least two further regions with a greater thickness compared therewith can have the same greater thickness. The regions of greater wall thickness can also have different wall thicknesses from one another, however. Preferably, however, they have the same greater thickness.

The sheet metal plate for producing the formed component is produced in particular by local ironing. In the process, the wall thickness is reduced, and thus ironed, and the sheet metal plate provided with partially different wall thicknesses is then fed to a further forming process.

As sheet metal material, use is made in particular of plates made of a steel material. It would also be conceivable to use plates made of a light metal alloy. In particular, it is also possible to use a hardenable steel material. The forming process can then be carried out as hot forming and press hardening.

The processed wall thicknesses are preferably in the range from 0.5 to 7 mm, in particular 1 to 5 mm, particularly preferably 1 to 3 mm The thinner or smaller wall thickness is preferably likewise in the abovementioned range. In particular, the smaller wall thickness, and thus the wall thickness in the thinner region, is reduced by 1 to 60%, in particular 1 to 40% compared with the thicker wall thickness. The wall thickness is in each case substantially constant in the regions with a smaller wall thickness and those with a greater wall thickness. This means that deviations in the scope of tenths or hundredths of a millimeter can occur on account of the ironing and forming process.

With the axle or chassis component according to an exemplary embodiment, it is thus possible to provide a weight reduction with simultaneous strength optimization. The regions which are subjected to greater load, or regions to which welded structures are attached, have a greater wall thickness. Regions which are subjected to less load compared therewith have a smaller wall thickness.

The formed component itself can be produced in particular by deep drawing. It is also conceivable in the scope of the invention for the formed component to be configured as a closed hollow component. To this end, a U-O forming method is used. This is advantageous in particular since the closed hollow profile has a smaller wall thickness radially circumferentially in an inner or central length portion. By contrast, the end portions have a greater wall thickness. The cross-sectionally closed hollow profile thus has a wall thickness that is adapted optimally in each case to the strengths demanded.

In particular, the component is produced as an axle subframe. The axle subframe is formed by a plurality of parts which are coupled together by welding. In particular, the axle subframe has two longitudinal members extending in the longitudinal direction. The two longitudinal members are coupled together by preferably two cross members extending in the vehicle transverse direction. At least one longitudinal member and/or cross member, preferably both longitudinal members and both cross members, are configured as formed components that are optimized in terms of wall thickness. Preferably a smaller wall thickness is formed between in each case two attachment points in a central region than in the respective attachment regions and/or end regions. The axle subframe according to the invention is thus produced in a load-optimized and at the same time weight-optimized manner The additional costs for the prior ironing of the sheet metal plate are low.

The abovementioned longitudinal members and cross members can be configured as cross-sectionally closed hollow profiles. However, they can also be configured as cross-sectionally open hollow profiles. In the case of an open hollow profile, the latter is configured in particular as a top hat profile and can be closed by a closing plate at least in length portions. The closing plate, too, can have wall thicknesses that differ from one another. In particular in a central region, the closing plate has a thinner wall thickness, compared with its end regions positioned in the longitudinal direction.

Further preferably, the axle or chassis component can be produced as a torsion profile of a torsion beam axle. The torsion profile is configured in particular in a U-shaped or O-shaped manner in cross section. The torsion profile preferably has, with respect to the longitudinal direction, a central region with a thinner wall thickness in relation to the adjacent external end regions with a greater wall thickness compared therewith.

At the ends of the torsion profile, in particular longitudinal swing arms are arranged. The longitudinal swing arms extend in the vehicle longitudinal direction in the installed state of the torsion beam axle. The longitudinal swing arms can in this case be coupled to the torsion profile in a form-fitting, force-fitting and/or materially bonded manner

### BRIEF DESCRIPTION OF THE DRAWINGS

For an understanding of embodiments of the disclosure, reference is now made to the following description taken in conjunction with the accompanying drawings, in which:

FIG. 1 shows a perspective view of an axle sub-carrier;

FIG. 2 shows a plate blank for producing a side arm;

FIGS. 3A to 3C show different views of an alternative design variant of a side arm;

FIGS. 4A to 4D show a plate blank and various method steps for producing a formed component;

FIG. 5 shows an alternative design variant of a plate blank for producing a side arm;

FIG. 6 shows a perspective view of an alternative design variant of an axle sub-carrier;

FIG. 7 shows a torsion tube for a torsion beam axle; and,

FIG. 8 shows a plate blank for producing a torsion tube.

In the figures, the same reference signs are used for identical or similar components, even if a repeated description is omitted for reasons of simplicity.

### DETAILED DESCRIPTION OF SOME EMBODIMENTS

Some embodiments will be now described with reference to the Figures.

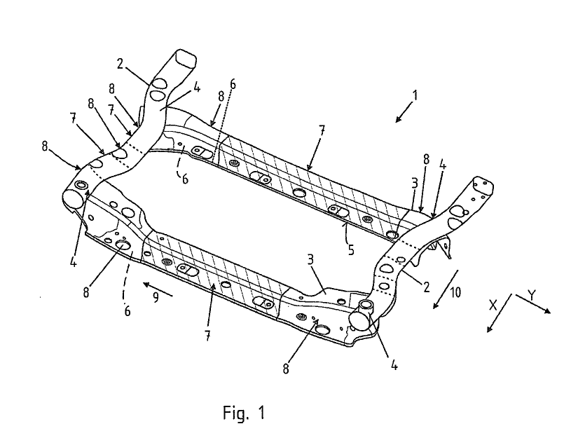

FIG. 1 shows a front axle carrier 1. The front axle carrier 1 is produced as a welded component assembly. The front axle carrier 1 is produced from two longitudinal members 2 extending in the vehicle longitudinal direction x. The longitudinal members 2 are coupled together via two cross members 3 extending in the vehicle transverse direction y. At coupling points 4, the cross members 3 and longitudinal members 2 are welded together via weld seams (not illustrated in more detail). The longitudinal members 2 are configured as closed hollow profiles 19 in cross section. In particular, the longitudinal members 2 can be produced by U-O forming.

The cross members 3 can also be referred to as cross bridges. The cross members 3 are configured as top hat profiles in cross section. It is also possible to configure the profiles as U-profiles or L-profiles in cross section. On an underside 5 of the cross members 3, the latter can be closed by a closing plate 6.

Moreover, according one exemplary embodiment, regions 7 with a thinner cross section W7 to be formed both in the cross member 3 and in the longitudinal member 2 in the respective longitudinal directions 9. The regions 7 are formed internally with respect to the longitudinal direction 9. In the region of the coupling points 4, the wall thickness W8 is configured to be greater in each case. In inner regions located between the coupling points 4, the wall thickness W7 is reduced compared therewith.

Thus, regions 7 with a reduced wall thickness W7 and regions 8 with a greater wall thickness W8 compared therewith are formed. The region 8 with a greater wall thickness W8 in this case corresponds in particular to the original wall thickness of the plate. The region 8 with a greater wall thickness W8 can also be ironed slightly, however. The region with a greater wall thickness W8 thus has a wall thickness which is smaller compared with the starting wall thickness of the plate. The region 7 with a smaller wall thickness W7 corresponds to an ironed region. As a result of the ironing, the wall thickness is reduced in the region of the ironing. For each cross member 3, an inner region 7, with respect to the longitudinal direction 9 of the cross member 3, with a smaller wall thickness W7 is formed. The respective end regions at the coupling points 4 have a greater wall thickness W8 compared therewith.

The longitudinal members 2 have two regions 7 with a reduced wall thickness W7 in their longitudinal direction 10 in the example shown here. Arranged between the two regions 7 with a reduced thickness W7 is a region 8 with a greater wall thickness W8. It is thus advantageously possible to produce the front axle carrier 1 appropriately in terms of load-bearing capacity such that the stiffness demands are met but at the same time the weight is reduced.

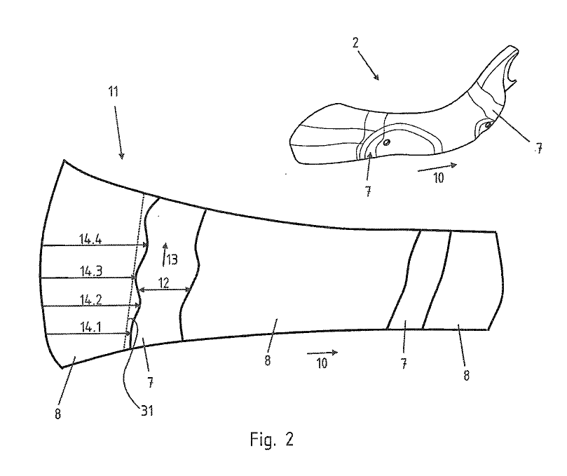

FIG. 2 shows a production process for a longitudinal member 2. First of all, a plate blank 11 is provided. In the plate blank 11, regions 7 with a reduced wall thickness W7 are formed and also regions 8 with a greater wall thickness W8 compared therewith. In this example, the regions 8 with a greater wall thickness W8 all have the same wall thickness, which corresponds to the wall thickness of the original plate, or is slightly less than the original wall thickness of the plate. The regions 7 with a smaller wall thickness W7 have a reduced wall thickness W7 compared with the greater wall thickness W8.

The regions 7 with a reduced wall thickness W7 have a width 12. This width 12 is preferably at least 20 mm and can extend along the majority of the longitudinal direction of the component to be produced. An advantage is that the width 12 does not have to have a constant distance over its transverse course 13. The width 12 can also have a varying distance over its transverse course 13. As a result, it is possible to produce regions 7 with a reduced wall thickness W7 in portions on the component to be produced, and thus on the longitudinal member 2 illustrated here, in the longitudinal direction 10 thereof. However, the region 7 does not begin and end at a particular point in the longitudinal direction 10 circumferentially. As a result of the production of the plate blank 11, it is possible to reduce the width 12 starting at the respective positions 14.1 to 14.4 in the longitudinal direction 10 over the subsequently to be produced circumferential contour, in the case of a closed hollow component around the circumference, although the latter does not have to be circular. Some positions 14.1 to 14.4 with respect to the longitudinal direction 10 are indicated in the plate blank 11. This is an advantage compared with rolling methods known from the prior art. The rolled region starts at the same position everywhere in the transverse direction, and this would be illustrated by the dashed rolling line 31. Transition regions between the regions 7 and 8 are not illustrated in FIG. 2.

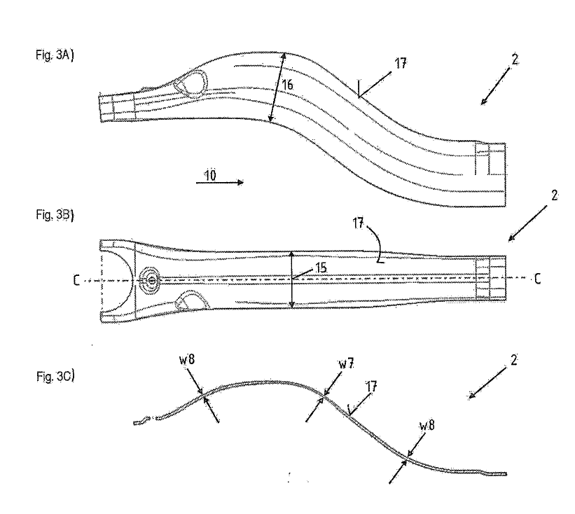

FIGS. 3a to 3c show a longitudinal member 2, or side arm, produced according to the invention, which is installed in a corresponding axle carrier. The side arm can be produced as a cross-sectionally closed hollow profile 19, but also as a cross-sectionally open hollow profile. In particular, this would be a U- or C-shaped profile. In the longitudinal direction 10, the longitudinal member 2 according to this example has a varying width 15 and a varying height 16. Thus, the cross-sectional contour varies along the longitudinal course. FIG. 3c shows in this case a section through the wall of the top side 17 of the longitudinal member 2. The wall thickness W8 is in this case configured to be greater in each case in a front and rear region with respect to the longitudinal direction 10. In an inner region 7, the wall thickness W7 is configured in a reduced manner

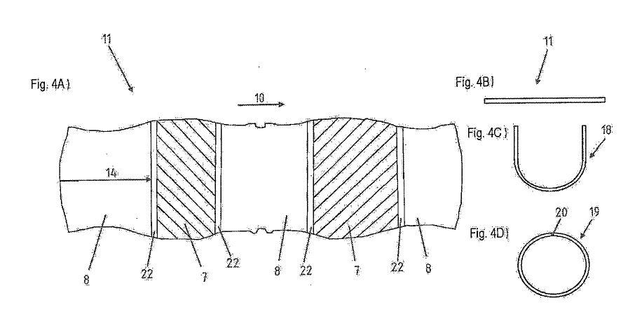

FIGS. 4a to 4d show a production method according to the invention for a corresponding formed component. First of all, here too, a plate blank 11 is provided. This plate blank 11 has regions 8 with a greater, in particular original wall thickness and regions 7 with a smaller wall thickness compared therewith. The outer contour of the plate blank 11 likewise varies, such that it is already adapted to the component to be produced. FIG. 4b shows the plate blank 11 in an exemplary cross-sectional view. In a first method step, the plate blank 11 is now formed as an open hollow profile 18 in cross section, illustrated in FIG. 4c. This method step is also referred to as U forming. Subsequently, the produced U is shaped into a closed hollow profile 19 in a further forming step, this also be referred to as O forming. Optionally, this can be closed via a joining seam 20 at the end sides resting against one another. In the longitudinal direction 10, the cross-sectional contour, and thus the cross-sectional area or cross-sectional shape can vary. The cross-sectional area can increase or decrease. Likewise, the cross-sectional shape can take on correspondingly different geometries along the longitudinal course. In the produced regions 7 with a thinner wall thickness, the wall thickness is accordingly smaller. In the plate blank 11 illustrated in FIG. 4a, the regions 7 with a thinner wall thickness W7 start substantially all at the same position in the longitudinal direction. Arranged between each of the regions 7 and 8 is a transition region 22 in which the wall thickness increases or decreases.

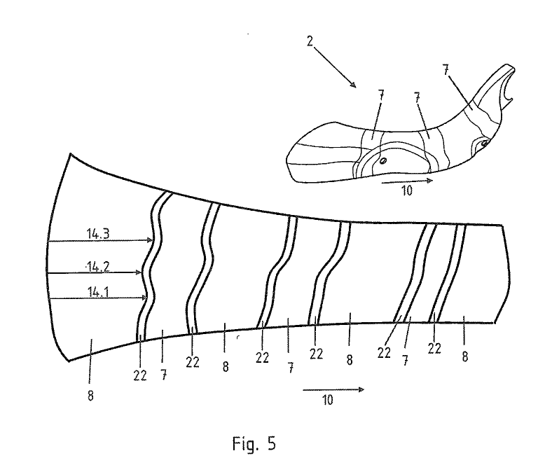

FIG. 5 shows an alternative design variant to FIG. 2. In this case, three regions 7 with a reduced wall thickness are formed in the longitudinal member 2. All of the regions 7 are located on the inside with respect to the longitudinal direction 10 of the longitudinal member 2, i.e. are enclosed by regions 8 with a greater wall thickness. However, the regions 7 extend across the entire plate blank in the widthwise direction. The positions 14.1 to 14.4 at which the region 7 with a thinner wall thickness starts or stops in the longitudinal direction 10 of the longitudinal member 2 can vary over the transverse course, as is indicated here. As a result of this, too, it is possible to position the thin regions individually not only in the longitudinal direction 10 but also in the transverse direction, such that a wall thickness that is appropriate in terms of load-bearing capacity is set in an exact position on the formed component to be produced. This differentiates it in particular from tailored rolled blanks, in which the start of the smaller wall thickness W7 in the longitudinal direction 10 is the same in the entire transverse direction on account of the roller pair.

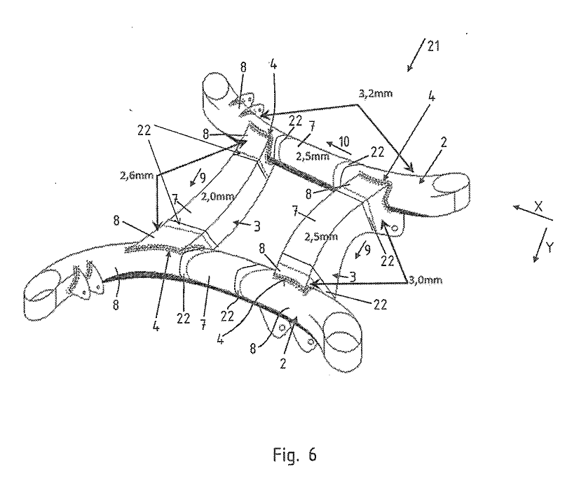

FIG. 6 shows an axle carrier as a rear axle carrier. The rear axle carrier, too, is produced from two longitudinal members 2 which are connected together via two cross members 3. The longitudinal members 2 extend in the vehicle longitudinal direction x and the cross members 3 in the vehicle transverse direction y. The cross-sectional contour and cross-sectional position of the longitudinal member 2 and cross member 3 changes over the respective course thereof in the longitudinal direction 9, 10. Illustrated here are respectively external regions 8 with a greater, in particular original wall thickness W8 and internal regions 7 with a reduced wall thickness W7 compared therewith. The respective components produced by forming, i.e. cross members 3 and longitudinal members 2, are joined together via coupling points 4. At the coupling points 4, they are connected together in particular via weld seams. Formed between the respective regions with an original wall thickness and a reduced wall thickness compared therewith are transition regions 22. The transition regions 22 preferably have a width of at least 20 mm in the respective longitudinal directions 9, 10 of the formed component. Also illustrated are exemplary but nonlimiting thickness indications in mm for the respective wall thicknesses. In the transition region 22, the wall thickness then decreases from the thicker wall thickness to the thinner wall thickness, or increases. The transition region 22 has in particular a degressive profile from greater to smaller wall thickness in the longitudinal direction. The longitudinal members 2 are formed as cross-sectionally closed hollow components in this example, and the cross members 3 as cross-sectionally open hollow components. The longitudinal members 2 can be formed in a substantially round manner in cross section, although this does not necessarily mean circular. The cross members 3 can be formed in a cross-sectionally polygonal manner. The choice of the cross section can also be different.

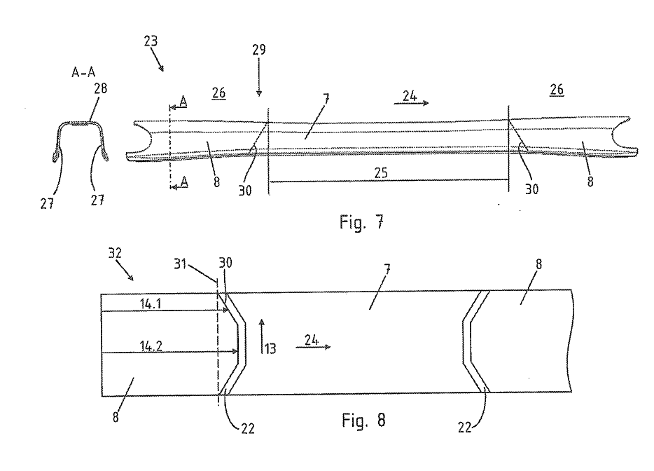

FIG. 7 shows a torsion profile 23, produced according to the invention, for a torsion beam axle. The torsion profile 23 is produced according to the invention with a U-shaped cross section, this being rendered apparent by the section line A-A. The torsion profile 23 is produced as a single shell, in one piece and from a single material. In its longitudinal direction 24, the torsion profile 23 has a central region 25 with a reduced wall thickness. Here too, it is possible to produce, by way of a previously produced sheet metal blank, a central longitudinal portion which has a smaller wall thickness in a central region 25. The end regions 26 of the torsion profile 23 that adjoin said central region 25 in the longitudinal direction 24 have a greater wall thickness W8 compared therewith, which corresponds in particular to the original wall thickness of the provided plate. As a result of this, too, it is possible to deliberately design the torsion profile 23 appropriately in terms of load-bearing capacity with a greater thickness W8 in its end region 26, in particular for the attachment of longitudinal members 2 and/or retaining components to a motor vehicle body, whereas a central less heavily loaded region 25 has a reduced wall thickness. Here too, it is again possible to make the position at which different wall thicknesses start in the longitudinal direction 24 vary over the transverse course 13. For example, it is possible here, in the legs 27 of the U-shaped cross-sectional profile, for the position, with respect to the ends of the legs 27, and thus in the transverse direction, at which the region 7 with smaller wall thicknesses starts, to be shifted toward the end portions. This is illustrated by way of the dashed line 30. The transition from original wall thickness to smaller wall thickness is thus not constant in the transverse direction 29 or over the transverse course 13, but is freely selectable along the longitudinal course and over the transverse course 13 on account of the ironing process.

FIG. 8 shows a plate blank 32 for producing a torsion profile 23. The positions 14.1, 14.2, at which the transition from region 8 to region 7 is formed, vary. The positions 14.1, 14.2 also increase in a V-shaped manner toward the outside. This is considered in contrast to a tailored rolled blank, which would have a constant, linearly extending rolling line 31. The position of the transition region 22 between region 7 and 8 is thus nonlinear in the transverse direction or over the transverse course 13.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. A component for an axle of a motor vehicle, comprising: at least two regions, wherein the first region has a smaller wall thickness (W7) in relation to the the second region, and wherein at least a part of the component is formed of a single material as a one-piece component.

2. The component according to claim 1, wherein the formed component has at least three regions, wherein the the first region with a smaller wall thickness (W7) is arranged at least partially between the other regions with a greater wall thickness (W8).

3. The component according to claim 1, wherein between the two regions with different wall thicknesses, a transition region is formed which has a width of 1 to 100 mm.

4. The component according to claim 1, wherein the wall thickness (W7) in the thinner region is reduced by 1 to 60%, and/or in that the greater wall thickness (W8) is 1 to 4 mm.

5. The component according to claim 1, wherein the component is produced from an ironed sheet metal plate having at least three regions with different wall thicknesses (W7, W8), and in particular the two regions with a greater wall thickness (W8) have an identical wall thickness.

6. The component according to claim 1, wherein an axle subframe which is produced as an assembled welded component made up of a formed component and a further component, wherein a greater wall thickness (W8) is formed in an attachment region and/or at a weld seam in relation to an adjacent wall thickness (W7).

7. The component according to claim 1, wherein the component is formed from two longitudinal members which are connected together via two cross members.

8. The component according to claim 6, wherein the cross members have a central region with a reduced wall thickness (W7), and/or in that the longitudinal members have a region with a reduced wall thickness (W7) between an attachment region of the two cross members

9. The component according to claim 6, wherein the cross member is configured as a hollow profile that is open on one side and is closed by a closing plate at least in length portions.

10. The component according to claim 5, wherein the component is a torsion profile of a torsion beam axle, wherein the torsion profile has a thinner wall thickness in a central region with respect to the longitudinal direction in relation to the adjacent external end regions with a greater wall thickness.

11. The component according to claim 10, wherein the torsion profile is configured in a U-shaped or O-shaped manner in cross section.

12. The component according to claim 3, wherein the width of 1 to 100 mm comprises a width of 2 to 80 mm.

13. The component according to claim 3, wherein the width of 1 to 100 mm comprises a width of 20 to 50 mm.

14. The component according to claim 4, wherein the reduction by 1 to 60% comprises reduction by 1 to 40%.

15. The component according to claim 4, wherein the wall thickness of 1 to 4 mm comprises a wall thickness of 1 to 2 mm.
